(19) United States
(12) Patent Application Publication
(10) Pub. No.: US 2003/0167187 A1
(43) Pub. Date: Sep. 4, 2003

(54) Systems and methods of determining performance ratings of health care facilities and providing user access to performance information

(76) Inventor: Robert N. Bua, Wellesley, MA (US)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/371,721

(22) Filed: Feb. 19, 2003

Related U.S. Application Data
(60) Provisional application No. 60/357,903, filed on Feb. 19, 2002.

(51) Int. Cl. G21C 17/00; G06F 15/00

(52) U.S. Cl. 705/2; 702/182

(57) ABSTRACT

The invention provides systems and methods of determining a performance rating of a health care facility, such as a nursing home or a long term care facility. The systems and methods according to the invention employ customizable scores and weighting factors by which performance data and information are processed to generate a performance rating of a facility, including current and historical ratings. The customizable scores and weighting factors are determined by or based upon a preferred set of criteria. In one embodiment, the customizable scores and weighting factors used in the methods and systems according to the invention include scores and factors that are indicative of and account for the relative importance of violations and deficiencies of standards of care to a facility's performance rating. The invention further provides computer implemented methods and systems for providing services for user access to data and information related to performance of a health care facility wherein such data and information includes performance ratings determined according to the systems and methods of the invention.

### CLAIM OF PRIORITY TO PRIOR APPLICATION

This application claims priority under 35 U.S.C. § 119(e) to U.S. provisional patent application Serial No. 60/357,903, filed on Feb. 19, 2002, which is incorporated herein by reference.

### NOTICE OF COPYRIGHT

A portion of the disclosure of this patent application contains material that is subject to copyright protection. The owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

Embodiments of the invention are generally directed to systems and methods of assessing performance of a health care facility and providing user access to information related to such performance.

### BACKGROUND OF THE INVENTION

As people live longer, the aging process and its related ills present an ever-increasing demand for nursing home care. Nursing homes are a major player in the multibillion-dollar health care industry. Although some types of nursing homes are intended to serve people of varying ages, most nursing homes provide skilled care and custodial care to elder individuals who do not need the intensive, acute care of a hospital, but cannot remain in their own homes. Nursing homes can provide a variety of services including rest home convalescence, sub-acute care, e.g., intensive, hospital-like care, skilled nursing, custodial care, and rehabilitation. The demand for nursing home care continues to increase as people live longer and as the elderly comprise a larger portion of the population as a whole.

Most nursing home residents in the United States are elderly, frail and at least somewhat compromised in their ability to be completely independent. Choosing a safe, dependable, high-quality nursing home, however, can be a frustrating and emotional experience. Among the challenges facing a consumer is the difficulty of understanding conventional ratings systems and rankings that now exists that provide performance information about nursing homes.

To help protect persons living in more than 17,000 certified nursing homes nationwide, federal laws and regulations have been implemented to set minimum standards for nursing home care and conduct. The United States federal government, primarily through the administrative agency responsible for Medicare and Medicaid programs, promulgates and enforces laws and regulations to set minimum standards of nursing home and home health care and conduct. On a regular basis, each certified nursing home must undergo an unannounced government inspection survey conducted pursuant to uniform procedures established and enforced by the Department of Health and Human Services. The inspection survey is used to assess a facility's compliance with federal nursing home laws and regulations.

For example, survey data and other information is generated by organizations such as the Center for Medicare and Medicaid Services (CMS) (formerly known as the Health Care Financing Administration (HCFA)), which performs a number of quality-focused activities, including regulation of laboratory testing, development of coverage policies and quality-of-care improvement, maintaining oversight of the survey and certification of nursing homes and continuing care providers, such as home health agencies, intermediate care facilities for the mentally retarded, and hospitals. CMS makes information about these activities and nursing home quality available to beneficiaries, providers, researchers, and state surveyors. This information, however, is not necessarily in a format whereby a user can make meaningful comparisons between health care providers.

In addition to federal regulation, organizations such as the Joint Commission on Accreditation of Healthcare Organizations (JCAHO), a private organization, compile voluntary compliance data with respect to a separate set of comprehensive health care standards.

Although the government has enacted such laws and regulations setting minimum standards of nursing home care and conduct, including the mandatory inspections, the governmental data resulting from these laws and regulations often is not helpful to average consumers. The format and type of such data, in particular, can be confusing and difficult to access and is presented in a manner that precludes a direct comparison of nursing homes by average consumers. Therefore, it is desirable to provide information related to nursing home care and conduct in a manner and in a format that permits consumers to compare performance and care of nursing homes and to make informed decisions, for instance, in connection with selection of an appropriate nursing home.

### SUMMARY OF THE INVENTION

The invention is directed to improved methods and systems for determining a performance rating of a health care facility and of providing user access to such performance ratings and associated information. In one aspect, a computer implemented method or system of determining a performance rating of a health care facility, such as a nursing home or a long term care facility, based upon customizable scores and/or weighting factors is provided. The method further includes determining current and historical performance ratings of a health care facility. In another aspect, a computer implemented method or system for providing services for user access to data and information related to performance of a health care facility is provided, wherein the data and information include performance ratings determined according to a method of the invention.

Various aspects of the invention may provide one or more of the following advantages. The methods and systems according to the invention of determining a performance rating of a health care facility can collect, interpret and process raw data and information from a variety of sources, including, for example, federal and state inspection surveys and reports, compliance reports and records, data and information collected by organizations such as CMS and JCAHO, and data and information collected and managed by databases such as the Online Survey Certification and Reporting (OSCAR) database, to determine one or more performance ratings of the health care facility's performance that are understandable and meaningful to consumers. Data and information can be processed to determine the performance ratings by assigning customizable scores and/or customizable weighting factors to at least a portion of the data and information that relate to certain areas or aspects of care performance, e.g., performance violations and deficiencies, and processing such data and information using the scores and weighting factors to generate performance ratings. The customizable scores and weighting factors can be determined and/or based upon a preferred set of criteria, for instance, that account for factors, variables, parameters and measures that relate to care performance of a health care facility.

The methods and systems of determining a performance rating of a heath care facility according to the invention can weight data and information, provided by the various sources noted above, using one or more customized scores and/or customized weighting factors that account for the relative importance of violations and deficiencies of certain health care standards or regulations in determining the performance rating. The methods and systems can also weight data and information using one or more customized weighting factors to account for the scope and the severity of each violation and deficiency at a health care facility and its impact on the facility's population in determining the performance rating. The customized weighting factors can be based, for example, upon various rationales with respect to the relative importance and the scope and severity of aspects of health care performance. The customized scores and weighting factors can be based upon analyses and judgments provided by one or more experts who are familiar with and/or specialize in care performance of a certain type of health care facility, such as a nursing home or a long term care facility. The methods and systems can thereby determine a performance rating of a health care facility that reflects the effects of performance violations and deficiencies on the quality of care provided by the facility and distinguishes the facility's care performance from that provided by other similarly rated health care facilities.

The performance ratings of a health care facility can be determined according to the methods and systems of the invention using, as noted above, federal and state inspection data to base the performance ratings on objective and resident-focused criteria and inspections that monitor a quality of life and a quality of care of the facility's residents and patients. The performance ratings of a health care facility can be based on data and information regarding all facilities certified by the United States government to include even those facilities with the worst or lowest ratings.

The performance ratings can be used to determine current and historical performance information about a health care facility over a given period of time, and can be used to determine comparative performance information that relates the facility's performance to other similar health care facilities. The comparative performance information can include rankings of similar health care facilities in a given geographical area or region, using city, county, state and national benchmarks to demonstrate those facilities that currently and historically outperformed or under performed their peers.

The methods and systems of determining a performance rating of a health care facility as described above can be implemented and conducted using a computer implemented system wherein the system is configured and arranged to implement and operate computer software programmed to determine a performance rating of a health care facility as noted above.

Services can be provided according to methods and systems of the invention to provide consumer access to the performance ratings of health care facilities and other performance related data and information. The performance ratings and related performance data and information can be provided to consumers as detailed comparative reports that allow consumers to review performance ratings and other information relating performance of health care facilities, such as nursing homes, that incorporates information from a variety of sources. The performance ratings can be represented or expressed using an easily understood rating system, e.g., an alphanumeric system whereby a performance rating is expressed as a letter, such as “AAA”, “AA”, “A”, “B”, “C” or “D”, and a performance rank is expressed as a numerical rank such as “150 out of 190” or “10 out of 25”, to provide consumers with an understandable benchmark by which to compare nursing homes.

Consumer access can be provided using computer implemented methods and systems that employs a network such as the Internet. Computer implemented methods and systems can be implemented, for instance, via a client-server system communicating through the Internet to provide services for consumer access to the detailed comparative reports described above. A computer or server system can receive from a client system, such as a personal or laptop computer, consumer queries or formatted search requests identifying certain criteria for information related to nursing homes and long term care facilities. In response, the computer or server system can provide to the client system the detailed comparative report of nursing homes and long term care facilities that have characteristics that are in accord with or “match” the criteria identified in the consumer queries or formatted search requests.

The comparative reports can present the performance ratings and performance related data and information in a manner and a format that allows a consumer to review the performance of a health care facility, such as a nursing home, to compare its performance with similar facilities and to make an informed decision or selection of a facility with respect to, for instance, a facility's performance and the consumer's needs.

These and other advantages of the invention, along with the invention itself, will be more fully understood after a review of the following figures, detailed description, and claims.

### BRIEF DESCRIPTION OF THE DRAWINGS

FIG. 1 is an illustration of a computer system in which methods of the invention can be embodied.

FIG. 2 is a flow diagram of a method of determining a performance rating of a health care facility, such as a nursing home, according to one aspect of the invention.

FIG. 3 is a flow diagram of a method for providing services for user access to data and information related to care performance and performance ratings of one or more health care facilities according to another aspect of the invention wherein the performance ratings are determined by the method of FIG. 2.

FIGS. 4A-4C is a representative example of a search request module provided to a user according to the method of FIG. 3 to access performance ratings and performance related data and information about one or more health care facilities.

FIG. 5 is a representative example of performance ratings and performance related data and information about the one or more health care facilities provided according to the method of FIG. 3.

FIG. 6 is a representative example of a first page of a Summary Report, e.g., a Nursing Home Report, generated according to the method of FIG. 3.

FIG. 7 is a representative example of a second page of the Summary Report of FIG. 6.

FIGS. 8A-8B are representative examples of a third page of the Summary Report of FIG. 6.

FIGS. 9A-9B are representative examples of a fourth and a fifth page of the Summary Report of FIG. 6.

FIG. 10 is a representative example of a sixth page of the Summary Report of FIG. 6.

FIG. 11 is a representative example of a seventh page of the Summary Report of FIG. 6.

FIG. 12 is a representative example of an eighth page of the Summary Report of FIG. 6.

FIG. 13 is a representative example of a ninth page of the Summary Report of FIG. 6.

FIGS. 14A-14B are representative examples of a tenth and an eleventh page of the Summary Report of FIG. 6.

The drawings are not necessarily to scale with emphasis generally being placed upon illustrating aspects of the invention.

### DETAILED DESCRIPTION OF PREFERRED EMBODIMENTS

The invention is directed to a method of and system for determining a performance rating of a health care facility. The invention further provides a method of determining current and historical performance ratings of a health care facility such as a nursing home or a long term care facility. In another aspect, the invention provides a computer-implemented method of determining a performance rating of a health care facility. In a further aspect, the invention provides a computer implemented method for providing services for user access to data and information related to performance of a health care facility wherein such data and information includes current and historical performance ratings of the health care facility. In a related aspect of the invention, the computer-implemented method further includes providing such performance data and information in a manner and a format accessible and understandable to a user. Other embodiments are within the scope and spirit of the invention.

The specific terms used below to disclose the preferred embodiments of the invention are used for purposes of clarity. The invention, however, is not limited to the specific terms used to describe the preferred embodiments, and each term at least includes all technical and functional equivalents that operate in a similar manner to accomplish a similar purpose. For purposes of disclosing the invention, the terms “health care facility” and “facility” are used to refer to any type of health care or medical provider or facility such as, for instance, a nursing home or a long term care facility.

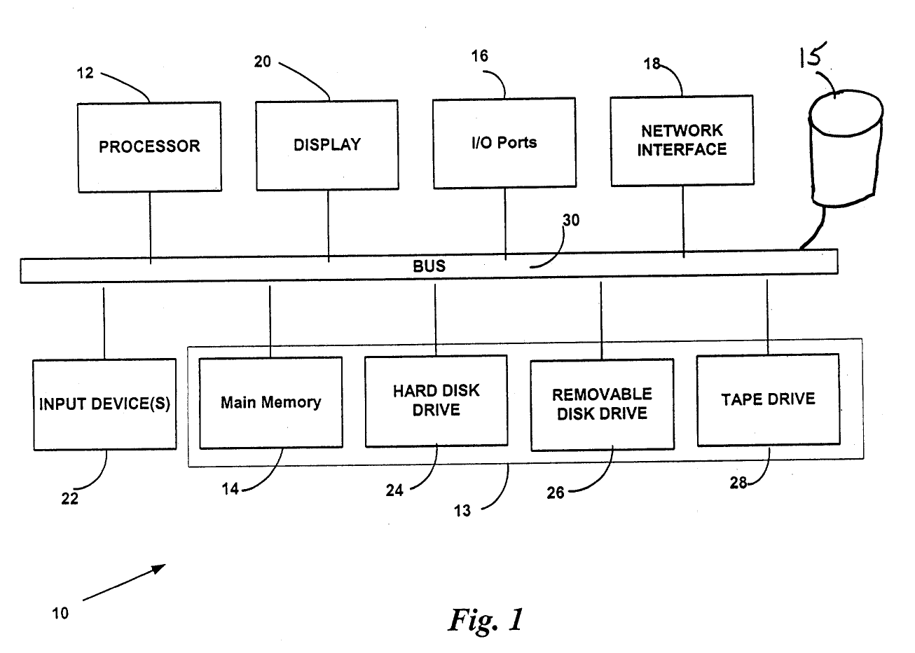

Referring to FIG. 1, in one aspect, the invention provides a computer-implemented system for implementing embodiments of the methods according to the invention, as described below in further detail. The computer-implemented system according to the invention can include a computer network that connects two or more general purpose computing devices, e.g., a general purpose computer system 10 as shown in FIG. 1. The configuration can be, for example, a client-server configuration or a peer-to-peer configuration. In one embodiment of the invention, the computer-implemented system can be incorporated with or implemented on a collection of networks and gateways that use the transmission control protocol/Internet protocol (TCP/IP) suite of protocols to communicate with one another, such as the Internet. The computer-implemented system can be accessible to users via software, such as a web browser, which allows end users to view hypertext markup language (HTML) documents and to access files and software related to such documents. For embodiments of the invention in which the computer-implemented system includes a computer network, such as the Internet, the representative examples of reports and results can be presented using many different types of World Wide Web (WWW) documents, including, for example, web pages written in HTML. In at least one embodiment, an HTTP or HTTPS server can present one or more HTML documents and associated files, scripts, and databases as a “web site.”

As noted, the computer-implemented system can connect two or more computing devices wherein each computing device can include the general purpose computer system 10 shown in FIG. 1. The general purpose computer system 10 can include, although is not limited to, a personal computer (PC), a laptop computer, a server, a workstation, a personal digital assistant (PDA), a mobile communications device, an interconnected group of general purpose computers and the like that runs any one of a variety of operating systems. A block diagram of the general-purpose computer system 10 usable with at least one embodiment of the invention is illustrated in FIG. 1.

The general purpose computer system 10 can include a central processor 12, associated memory 13 for storing programs and/or data, one or more input/output ports 16, a network interface 18, a display device 20, one or more input devices 22 and a data bus 30 coupling these components to allow communication between the components. The associated memory 13 can include main memory 14, random access memory (RAM) and/or read only memory (ROM) for storing programs and data, as well as a fixed or hard disk drive unit 24, a removable disk drive unit 26, such as a floppy disk or a CD-ROM drive, and/or a tape drive unit 28.

The central processor 12 can be any type of microprocessor, such as a PENTIUM processor, made by Intel of Santa Clara, Calif. The display device 20 can be any type of display, such as a liquid crystal display (LCD), cathode ray tube display (CRT), light emitting diode (LED), and the like, capable of displaying, in whole or in part, the outputs generated in accordance with the systems and methods of the invention. The input device 22 can be any type of device capable of providing the inputs described herein, such as keyboards, numeric keypads, touch screens, pointing devices, switches, styluses, and light pens. The network interface 18 can be any type of a device, card, adapter, or connector that enables the system 10 with wired or wireless network access to a computer or other network device. In one embodiment, the network interface 18 enables the system 10 to connect to the Internet.

Those skilled in the art will appreciate that the system 10 need not include every element shown in FIG. 1, and that equivalents to each of the elements are intended to be included within the scope and spirit of the invention. For example, the system 10 need not include the tape drive 28, and may include other types of memory, such as compact disk read-only memory (CD-ROM) or a random access memory (RAM). CD-ROM drives can, for example, be used to store some or all of the databases described herein.

In one embodiment, one or more computer programs define the operational capabilities of the system 10. These programs can be loaded into and stored on the system 10 in many ways, such as via a CD-ROM disk drive, the floppy disk drive 26, and the tape drive 28, or the network interface 18. Alternatively, the programs can reside in a permanent memory portion (e.g., a read-only-memory (ROM)) chip) of the main memory 14. In another embodiment, the computer system 10 can include specially designed, dedicated, hard-wired electronic circuits that perform all functions described herein without the need for instructions from computer programs.

In one embodiment, the system 10 can be or include a client-server system, in which a client sends requests to a server and a server responds to requests from a client. That is, the system 10 can include both the client and the server parts of the system. In one embodiment, the system 10 is implemented at the server side and receives and responds to requests from a client, such as a web browser application running on a user computer.

The client can be any entity, such as the computer system 10, or specific components thereof, e.g., terminal, personal computer, mainframe computer, workstation, hand-held device, electronic book, personal digital assistant, peripheral, etc., or a software program running on a computer directly or indirectly connected or connectable in any known or later-developed manner to any type of computer network, such as the Internet. For example, a representative client can be a personal computer that is based on an i86 or Pentium (from Intel Corp. Santa Clara, Calif.), PowerPC (IBM Armonk, N.Y.) or RISC microprocessor, that includes an operating system, such as IBM (Armonk, N.Y.), LINUX, Palm (Palm Computing, Milpitas, Calif.) or MICROSOFT WINDOWS (Microsoft Corporation, Redmond, Wash.) and that includes a Web browser, such as MICROSOFT INTERNET EXPLORER or NETSCAPE NAVIGATOR, (Netscape Corporation, Mountain View, Calif.), having a Java Virtual Machine (JVM) and support for application plug-ins or helper applications. A client can also be a notebook computer, a handheld computing device, e.g., a PDA, an Internet appliance, a telephone, an electronic reader device, or any other such device connectable to the computer network.

The server can be any entity, such as the computer system 10, a computer platform, an adjunct to a computer or platform, or any component thereof, such as a program that can respond to requests from a client. Of course, a “client” can be broadly construed to mean an entity that requests or gets the information requested, and “server” can be broadly construed to be the entity that sends or forwards the information requested. The server can include a display supporting a graphical user interface (GUI) for management and administration, and an Application Programming Interface (API) that provides extensions to enable application developers to extend and/or customize the core functionality thereof through software programs including Common Gateway Interface (CGI) programs, plug-ins, servlets, applets, active server pages, server side include (SSI) functions and the like.

In one embodiment, the invention provides computer implemented systems and methods that enable individuals, businesses, medical professionals, and other consumers or users (collectively, “users”) to obtain detailed information and reports about health care providers such as nursing homes. In accordance with one embodiment of the invention, users can use a computerized system via a website or portal, over a computer network to access a variety of features and functions. At least some embodiments of the invention provide features and functions whereby users can search for, view information about, and purchase reports relating to health care providers.

In addition, in some embodiments of the invention, the computer-implemented systems can provide features and functions whereby users can upload information about health care providers for use by other clients. The invention can help eliminate the need for users having to review a multitude of objective factual data simultaneously, to determine the performance of a facility in one or more areas (as well as overall) which can be confusing and stressful. The invention can be used to summarize the most relevant and important aspects of the data in a consistent and readily comparable way, so that users can quickly and easily determine whether a facility's performance in a particular area (as well as overall) meets their needs and can determine how a facility compares to other facilities.

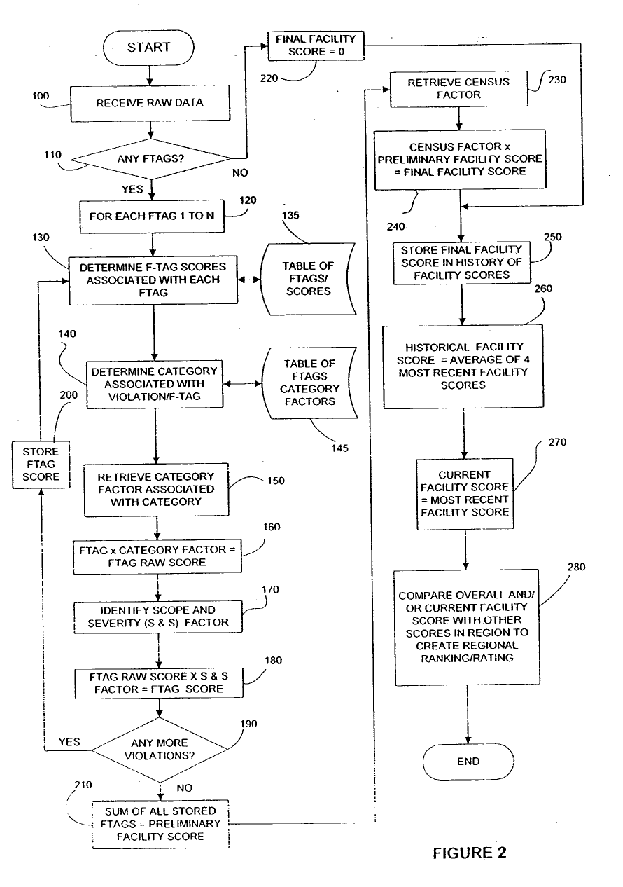

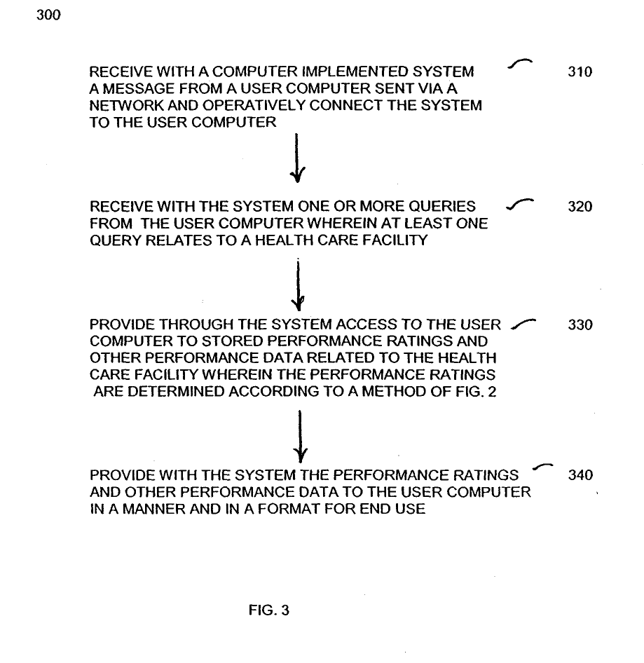

Referring to FIG. 2, in one aspect, the invention provides a computer implemented method 100 of determining a performance rating of a health care facility such as a nursing home or a long term care facility. In one embodiment, the method 100 is implemented using the general purpose computer system 10, as described with reference to and shown in FIG. 1. Those skilled in the art will recognize that other types of automatic processing systems are suitable for implementing the method 100 according to the invention. In this embodiment, the general purpose computer system 10 can be configured and arranged to implement computer software programmed to process data and information and to generate one or more performance ratings of a health care facility's performance. The computer software is configured to weight data and information related to performance of a health care facility using customized scores and customized weighting factors in accordance with the method 100 of the invention to account for performance standards, variables, parameters, and other factors that affect an importance of at least a portion of the data to a performance rating of the health care facility. Such performance factors, standards, variables and parameters related to a health care facility can include, for example, the types of violations and deficiencies of certain standards of care at the facility, the histories of such violations and deficiencies, information related to compliance of the facility within standards of care, such as long term care regulations, and the like. The method 100 according to the invention thereby determines a performance rating of a given health care facility to distinguish health care provided by the facility from care provided by other health care facilities.

The method 100 according to the invention, as described below, generally refers to determining a performance rating of a single health care facility at one time, although those skilled in the art will recognize that the method 100 is capable of determining simultaneously a performance rating for each of a number of health care facilities. In one embodiment, the method 100 includes stages, as described below, that the system 10 can be configured and arranged to carry out and the computer software is programmed to implement and to conduct to determine a performance rating of a health care facility. The method 100, however, is exemplary only and not limiting, and can be altered, e.g., by having stages added, removed or rearranged.

At stage 105, raw data and information about a health care facility is entered into the computer system 10 via an input device 22 or obtained from a remote source via network interface 18. The raw data and information can include detailed information about the health care facility's performance provided, for example, as one or more performance surveys and/or performance data, federal inspection surveys, reports and/or federal inspection data, state inspection surveys, reports and/or state inspection data, facility compliance data and/or compliance records, e.g., reports in connection with the facility's compliance with federal and/or state standards or long term care regulations. In addition, or alternatively, the raw data can include information collected by the Center for Medicare and Medicaid Services CMS), the Joint Commission on Accreditation of Healthcare Organizations (JCAHO), and the Online Survey Certification and Reporting (OSCAR) database. In at least one embodiment, the raw data received includes information associated with the United States Department of Health and Human Services. In other embodiments, the raw data and information can include other health care factors, standards, variables, and parameters as well as other health care performance identifiers, e.g., performance violations or deficiencies, in different areas or aspects of health care performance that correspond to one or more standards of care, e.g., as provided by long term care regulations associated with the U.S. Department of Health and Human Services. For example, performance identifiers referred to in the art as “F-tags” correspond to various violations or deficiencies within long term care regulations associated with the U.S. Department of Health and Human Services. F-tags correspond to different areas and aspects of care that, for example, an inspector of a nursing home or a long term care facility may identify or “tag” during an inspection as those areas and aspects of care that are deficient in or violate one or more long term care regulations. Examples of such performance identifiers or F-tags include, but are not limited to, F-tag F221, which refers to “restraints,” F-tag F32, which refers to “adequate supervision to prevent accidents,” and F-tag F323, which refers to “facility free of hazards.” In at least one embodiment, the raw data can further include information related to fire safety violations that, in one aspect, are referred to in the art as G-tags. A given “tag”, note, violation and/or deficiency assessed during an inspection of a facility can be associated with one or more F-tags and/or one or more G-tags. In one embodiment, the system 10 can be configured and arranged and the software can be programmed to assess the presence of F-tag violations and deficiencies from the raw data and information for further processing to determine an overall or total performance rating of the facility. The method 100 of the invention, however, is not limited to F-tag violations and deficiencies, but anticipates that other types of performance violations and deficiencies, and other measures, such as factors, standards, variables, parameters, identifiers and the like associated with the performance of and the quality of care provided by a health care facility, can be employed to determine an overall or total performance rating of the health care facility.

At stage 120, the software identifies each F-tag for further processing to initiate the method 100.

At stage 130, a raw or first score of an identified F-tag can be determined, calculated or identified by the system 10, e.g., via the microprocessor 12, according to instructions provided by the computer software. In one embodiment, a first score table 135, e.g., can be stored in the memory 14 and/or in one or more of the databases 15 associated with the system 10, and used to determine the first score of the identified F-tag. The first score table 135 includes a compilation of F-tag standards and one or more customized scores, e.g., numerical values, associated with or corresponding to each F-tag standard. Customized scores can include scores determined by or based upon a preferred rating system or method that assigns a score to the identified F-tag based upon a set of criteria. In one embodiment, the customized scores are determined with respect to the importance of the identified F-tag to the performance rating of the facility, as described below. The invention, however, is not limited with respect to a set of criteria on which the customized scores are determined or based, but anticipates other criteria can be used. A customized score corresponding to the identified F-tag can be identified, determined or calculated using the first score table 135 to produce the raw or first score. In one embodiment, the system 10 identifies and retrieves from the first table 135 a customized score associated with the identified F-tag.

The first table 135 can include, for example, an F-tag standard associated with an administrative violation, e.g., a record keeping error or deficiency, which can have a corresponding raw or first score of 10, and an F-tag standard associated with a cleanliness violation, which can have a corresponding raw or first score of 20. The relative scores corresponding to the F-tag standards indicate an importance or a weight of each F-tag violation and deficiency to a performance rating of the facility. For example, a score of 10 represents an F-tag violation of relative less importance or less weight to the performance rating of the facility than a score of 20. The respective scores of 10 and 20 as used herein, however, are merely illustrative of the method 100 according to the invention and other scales and/or scoring systems, e.g., an alphanumeric system, can be used to give a relative score or weight to an F-tag violation or deficiency with respect to its importance to the performance rating of the health care facility. In one embodiment, the first table 135 can include data and information that represent an expert's judgment about the importance of a given F-tag to the performance rating of a facility. An expert skilled in analyzing F-tag data, health care facilities performance data, and other related data and information could provide guidance for generating information and/or customized scores associated with F-tag standards that are integrated and compiled as the first score table 135. Those skilled in the art will appreciate that the raw or first scores associated with such performance identifiers as F-tags are subjective determinations and other rationales or different bases are applicable for determining a raw or first score associated with an F-tag in accordance with the invention.

At stage 140, the system 10 determines, calculates or identifies a first weighting factor for the identified F-tag. The first weighting factor can be used to weight, e.g., increase or decrease, the raw or first score of the identified F-tag with respect to its importance to the performance rating of the facility relative to the importance of other F-tags to the performance rating of the facility. In one embodiment, a second weighting factor table 145, e.g., can be stored in the memory 13 and/or in one or more of the databases 15 associated with the system 10, and can include a set of customized weighting factors, e.g., numerical values, associated with or corresponding to one or more F-tag standards. Customized weighting factors can include factors determined by or based upon a preferred rating system or method that determines or assigns a weighting factor to the identified F-tag based upon a set of criteria. A customized weighting factor corresponding to the identified F-tag is identified, determined or calculated using the second table 145 to produce a first weighting factor. In one embodiment, the system 10 identifies and retrieves from the second table 145 the first weighting score associated with the identified F-tag. In at least one embodiment, the first weighting factors are determined in advance of determining a performance rating of a facility.

The set of customized weighting factors of the second table 145 can include, for example, category factors, which classify performance violations and deficiencies represented by F-tags, as well as classify other performance factors, standards, variables and parameters identified by the system 10, into one or more categories of performance. The category factors can include numerical factors or values used to weight the importance of an F-tag with respect to the performance rating of the facility according to the one or more categories in which the F-tag is classified and relative to the importance of other F-tags in other categories of performance. The category factors can classify F-tags into, for example, an “administrative” category or a “quality of care” category. A factor corresponding to a “quality of care” category can weight more heavily, e.g., increase the importance of the F-tag to the performance rating, than a factor corresponding to an “administrative” category, thereby imputing a greater importance to an F-tag violation in a “quality of care” category to the performance rating of the facility than an “administrative” category. In one embodiment, the first weighting or category factors of the second table 145 are determined in a manner similar to that by which the raw or first scores of the first table 135 are determined. F-tag data, health care facilities performance data, as well as other related data and information, are analyzed, e.g., by an expert, and the customized first weighting or category factors are formulated based upon the analysis of the data and/or the judgment of an expert. Those skilled in the art will recognize that different methods and systems for determining and assigning a customized weight to a given factor, standard, variable, parameter and/or identifier associated with a performance of a health care facility can be used in accordance with the invention.

At stage 150, the system 10 retrieves one or more stored first weighting or category factors identified in the second table 145 that correspond to the identified F-tag.

At stage 160, the system 10 weights the raw or first score of the identified F-tag of stage 130 by the one or more first weighting or category factors of stage 140 to produce a raw or second weighted F-tag score that relates to the violation and/or deficiency the identified F-tag represents. In one embodiment, the first weighting or category factors can include a range of numerical values, e.g., from 0.8 to 1.2, by which the raw or first score is multiplied to produce the second weighted F-tag score.

At stage 170, the system 10 determines, calculates or identifies a second weighting factor that relates to the scope and severity of the identified F-tag at the facility. The second weighting factor is determined from a set of customized scope and severity factors, e.g., that can be stored in the memory 13 and/or in one or more of the databases associated with the system 10. Each customized scope and severity factor relates to a scope of the identified F-tag at the facility and a severity of the identified F-tag with respect to potential and actual harm to the patients at the facility. The scope and severity factor can weight, e.g., increase or decrease, the raw or second F-tag score to account for the extent and severity of the violation and/or deficiency in determining the performance rating of the facility. In one embodiment, the set of customized scope and severity factors can be determined, calculated or identified using the Scope and Severity Rating Grid employed by the United States government to determine or identify a scope and severity grade and then associating a customized weighting factor, e.g., a numerical value, to the scope and severity grade that is indicative of the relative weight or importance of the scope and severity grade to the performance rating of the facility. In one embodiment, the scope and severity grade of the identified F-tag is determined using an alphanumeric scale that provides a range of severity ratings, e.g., from least serious to most serious. Within a given severity rating, the scope of the identified F-tag is determined using additional alphanumeric characters to represent the scope or how widespread the identified F-tag is at the facility. Table I provided below is a representative example of a Scope and Severity Rating System used in accordance with one embodiment of the invention.

TABLE I
Scope and Severity Rating System¹

| | | Scope & |
|---|---|---|
| | Scope of | Severity |
| Description of Severity of Offense | Offense | Factor |
| Substantial Compliance; no actual harm and no | Isolated | A |
| more than minimal harm possible | | |
| Substantial Compliance; no actual harm and no | Pattern/ | B |
| more than minimal harm possible | Regular | |
| Substantial Compliance; no actual harm and no | Widespread | C |
| more than min. harm possible | | |
| No actual Harm, but there is potential for more | Isolated | D |
| than minimum harm | | |
| No actual Harm, but there is potential for more | Pattern/ | E |
| than minimum harm | Regular | |
| No actual Harm, but there is potential for more | Widespread | F |
| than minimum harm | | |
| Actual harm, but not immediate jeopardy | Isolated | G |
| Actual harm, but not immediate jeopardy | Pattern/ | H |
| | Regular | |
| Actual harm, but not immediate jeopardy | Widespread | I |
| Immediate jeopardy to health and safety of | Isolated | J |
| residents | | |
| Immediate jeopardy to health and safety of | Pattern/ | J |
| residents | Regular | |

¹Source of Table I: Nursing Home Regulations Manual, referring to Center for Medicare & Medicaid Services, Thompson Publishing Group.

Using the Scope and Severity Rating System of Table I, an assessment can be made of whether the identified F-tag violation and/or deficiency poses a potential for more than minimal harm in the context of care performance. The method 100 according to the invention, however, is not limited to F-tags, but anticipates that other performance violations and deficiencies and other performance measures, such as factors, standards, variables, parameters, identifiers and the like associated with the performance of and the quality of care provided by a health care facility, can be similarly weighted to account for their respective potentials for harm in the context of care performance. One or more customized scope and severity factors, e.g., numerical values, can be associated with each scope and severity grade identified in Table I. In one embodiment, the customized scope and severity factors can be derived and/or based on an expert review and analysis of historical facility data with respect to long term care performance within a certain period of time. The second weighting or scope and severity factors, in this embodiment, represent an expert's judgment with respect to how an F-tag violation and/or deficiency having a given scope and severity grade should affect a performance rating of the facility. For example, F-tags that are rated as having an “L” scope and severity grade can be determined to be so important to a facility's overall or total performance rating or score that the weighting factor, e.g., numerical value, corresponding to the “L” scope and severity grade is set to maximize a contribution of the respective F-tag violations and/or deficiencies to the overall or total performance rating. As another example, in one embodiment, the scope and severity grade of “E” is assigned a weighting factor that is less than the weighting factor assigned to the “L” scope and severity grade. In one embodiment, the system 10 retrieves the second weighting or customized scope and severity factor associated with the identified F-tag from the set of stored scope and severity factors wherein the factors are represented by numerical values in a range from 0.85 to 1.25.

At stage 180, the system 10 weights, e.g., increases or decreases, the raw or second F-tag score of stage 160 by the retrieved second weighting or scope and severity factor to produce a final F-tag score. In one embodiment, the second F-tag score is multiplied by the scope and severity factor to produce a final F-tag score. The final F-tag score can represent a performance rating of a facility with respect to the type of F-tag violation and/or deficiency and its scope and severity at the facility.

At stage 190, if the system 10 identifies other F-tag violations or deficiencies in the raw data entered at stage 100, the identified F-tags are processed according to the method 100, as described above with respect to stages 110 through 180.

At stage 200, the system 10 stores the final F-tag score of stage 180, e.g., in the memory 13 and/or in one or more of the databases 15, such that the system 10 can retrieve the final F-tag score at a later time to process the identified F-tag and/or to compute the performance rating of the facility, as described below in further detail. The system 10 similarly stores additional final F-tag scores of stage 190 for later retrieval and use in computing the facility's performance rating.

At stage 210, the system 10 retrieves the stored final F-tag score, as well as other stored final F-tag scores of stage 190, and adds the final F-tag scores to produce a sum that represents a preliminary facility score. The system 10 thereafter stores the preliminary facility score.

At stage 230, the computer system 10 retrieves a stored census factor from the memory 14 and/or from one or more of the databases 15. In at least one embodiment, the census factor is a weight or value, e.g., a numerical value that is used to adjust or normalize the preliminary facility score of stage 210 for comparative purposes. In one embodiment, the census factor includes a demographic factor that normalizes raw score data of stage 105 based on, for instance, different population sizes. In another embodiment, the census factor can include a demographic factor that normalizes the preliminary facility score of stage 210. For example, if a facility, e.g., a nursing home or a long term care facility, has a population size of 50 patients, its preliminary facility score can be normalized to a certain standard patient population size, e.g., 100 patients, by multiplying the score by the census factor, e.g., a demographic factor having a value of two. The census factor thereby helps to adjust the preliminary facility score to more accurately reflect the impact of the assessed violations and deficiencies versus a standard population size of a nursing home or a long term care facility. For example, 5 violations found in a facility with a population of 20 patients can be viewed as more significant with respect to the performance of the facility than 5 violations found in a facility with a patient population of 150. The census factor in essence grades the preliminary facility score to account for situations having such as different patient population sizes. Those skilled in the art will recognize that the method 100 is not limited to a census or demographic factor, but anticipates other factors, variables, parameters and situations that can serve as bases or rationales for census factors where applying a census factor to any of the scores determined according to the invention is necessary or recommended.

At stage 240, the system 10 normalizes the preliminary facility score of stage 210 by the census factor of stage 230 to provide a final facility score or performance rating. In one embodiment, the system 10 multiplies the preliminary facility score by the census factor to produce the final facility score or performance rating of the facility.

At stage 250, the system 10 stores the final facility score or performance rating in a history of final facility scores of the facility stored in the memory 13 and/or in one or more of the databases 15 such that the score or rating can be retrieved at a later time either alone or in conjunction with other stored scores or ratings, e.g., as a set or history of scores or ratings.

The final facility score or performance rating of step 240 represents an assessment of the overall or total performance of the facility with respect to the care performance and the quality of care provided, taking into account the factors described above. The performance rating can be represented in any manner that is readily identifiable and easily understandable to a user. For example, the performance rating can be represented as a numerical rank, e.g., 95 out of 100 facilities, or an alphabetical score, e.g., expressed as a letter such as AAA, AA, A, B, BB, C, D, etc., or an alphanumeric rating, e.g., A1, B2, C3, etc., or a set of indicators, e.g., one check (√), two checks (√√), etc., or any other type of scoring, grading or rating system or method, to convey the performance rating of the facility. In one embodiment, the final facility score or performance rating of stage 240 is converted to an alphabetical rating. An advantage of representing the final facility score or performance rating as an alphabetical rating versus other methods or systems is that the alphabetical rating can provide a universally understood rating and can also provide precision with respect to informing a user about the performance or the quality of care provided by the facility.

The final facility score or performance rating helps to summarize and provide for a user a single rating from which to assess a health care facility's performance. The performance rating comprises the most relevant and important aspects of the raw data and information related to the facility's performance. These important aspects, as described above, can be related to identified F-tags, as well as other performance violations and deficiencies and other measures, such as factors, standards, variable, parameters, identifiers and the like related to the care performance of a health care facility. As noted above, factors that affect an importance of F-tag violations and deficiencies to the performance rating of a facility can include the type of identified F-tags, the scope and severity factors associated with the impact of identified F-tags, the history of F-tag violations and deficiencies and the F-tags impact on a patient population of a given size. The performance rating as determined by the method 100 of the invention can help to eliminate or reduce a consumer's need to review a multitude of objective factual data simultaneously to determine or assess the performance of a facility in one or more areas of care as well as with respect to the overall or total performance of the facility. The performance rating helps consumers easily and relatively quickly determine whether a facility's performance will meet their needs and/or expectations.

At stage 260, the system 10 can determine, calculate or identify an historical facility score from the final facility scores or performance ratings of stage 250 that are stored in the set or history of final facility scores. The system 10 computes the historical facility score by retrieving a certain number of the most recent final facility scores of stage 250, e.g., the last four scores, and averaging the final facility scores or performance ratings to provide an average historical facility score. The method 100 according to the invention, however, is not limited to the number of final facility scores the system 10 uses to compute the average historical facility score.

At stage 270, the system 10 stores the most recent final facility score or performance rating such that the rating is designated or identified as a “current” facility score.

At stage 280, the system 10 compares the facility's final facility score or performance rating of stage 240 with stored final facility scores or performance ratings of other similar facilities as determined according to the method 100 of the invention to create a comparative performance “Rating” and to create a comparative performance “Ranking” (Rank) of the facility. The “Rating” and the “Ranking” of the facility provide single values that enable users to easily discern and understand the care performance and the quality of care of the facility as compared to other similar facilities.

In one embodiment, the facility's performance rating of stage 240 is compared with the performance ratings of similar facilities in a given geographic region or area, e.g., a town, city, county or state, to create a performance “Rating” and “Ranking” of the facility in the given region or area. In one embodiment, the system 10 determines or calculates the relative performance “Rating” of the facility as noted above, and represents or expresses the “Rating” as an alphabetical rating, e.g., AAA, AA, A, BB, B, C, D, etc. The alphabetical performance rating reflects the results of the system's 10 comparison of the facilities. In another embodiment, the system 10 determines or calculates the comparative “Ranking” of the facility by a comparison of its performance rating with the performance ratings of other facilities within the given region or area to provide a relative “Ranking” of the facility among the other facilities. The “Ranking” can be expressed as a numeral that reflects its position within the total population of facilities in the given region or area, e.g., 265 out of 510 facilities.

In one embodiment, the system 10 can determine the comparative “Rating” of the facility based upon a comparison of its current final facility score or performance rating with the current final facility scores of other similar facilities in the given region or area to provide a “Current Rating” of the facility, e.g., expressed as a “Current County Rating” or a “Current State Rating”. Similarly, the system 10 can determine the comparative “Ranking” of the facility as a current comparative ranking based upon the current final facility scores of the facilities in the given region or area, and can provide a “Current Ranking”, e.g., a “Current County Ranking” or a “Current State Ranking”. In another embodiment, the system 10 can determine the comparative “Rating and “Ranking” of the facility as a “Historical Rating” and a “Historical Ranking” based upon a comparison of the historical final facility scores or performance ratings of the facility and other similar facilities in the given region or area.

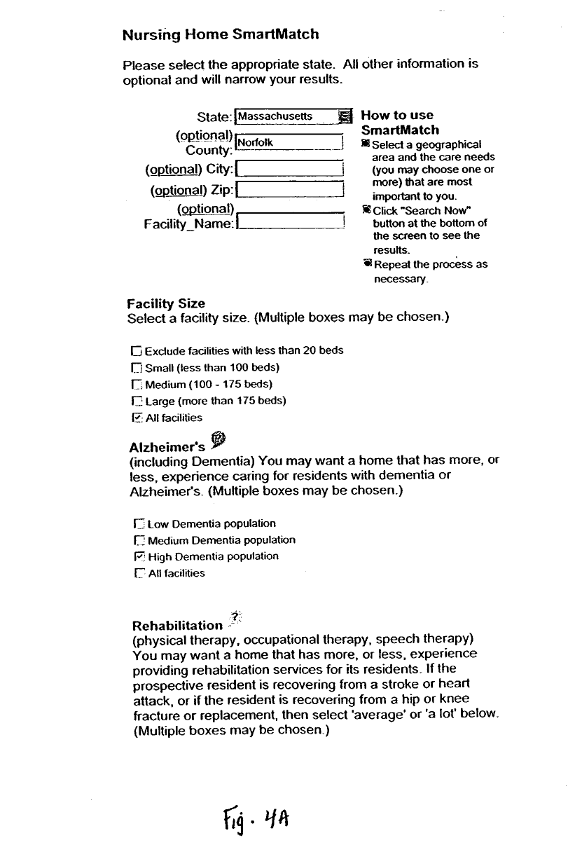

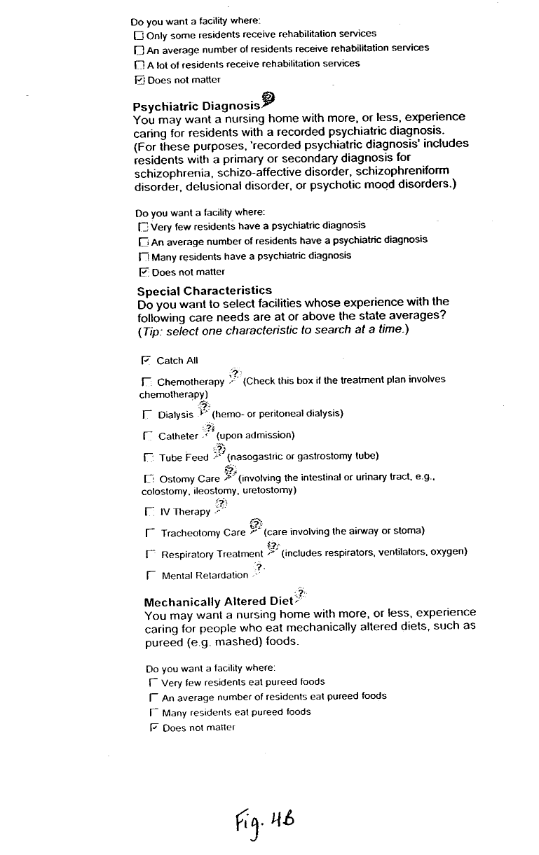

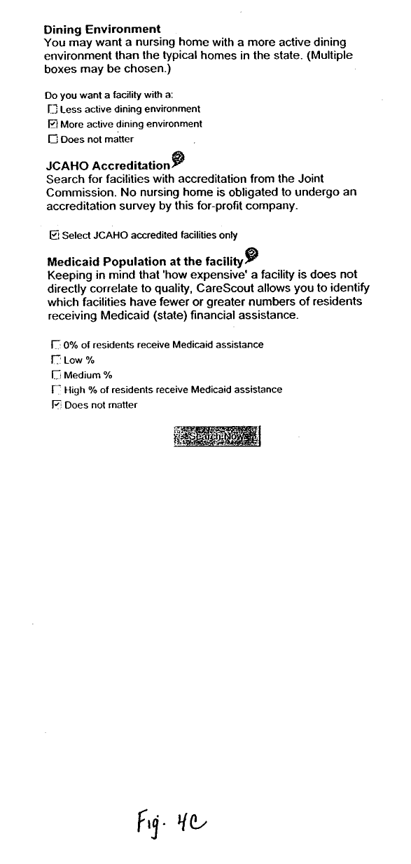

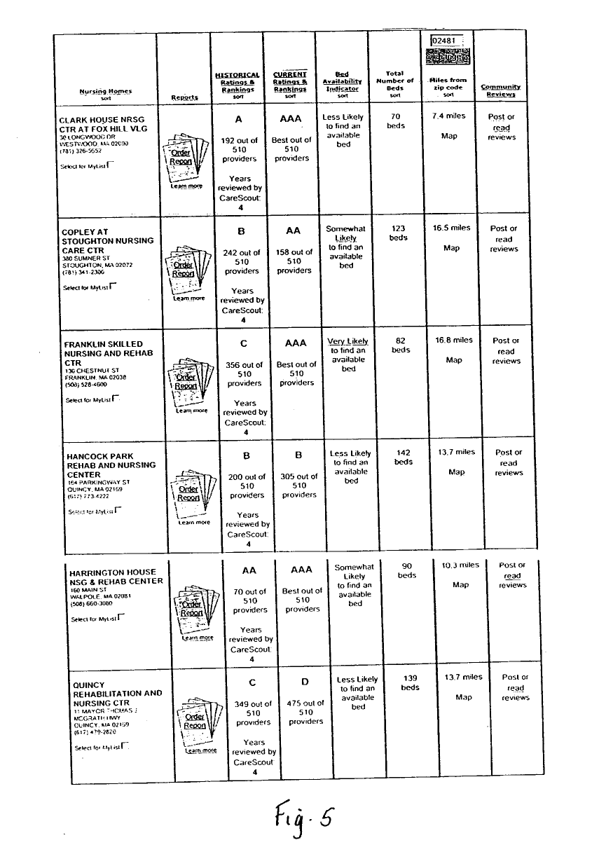

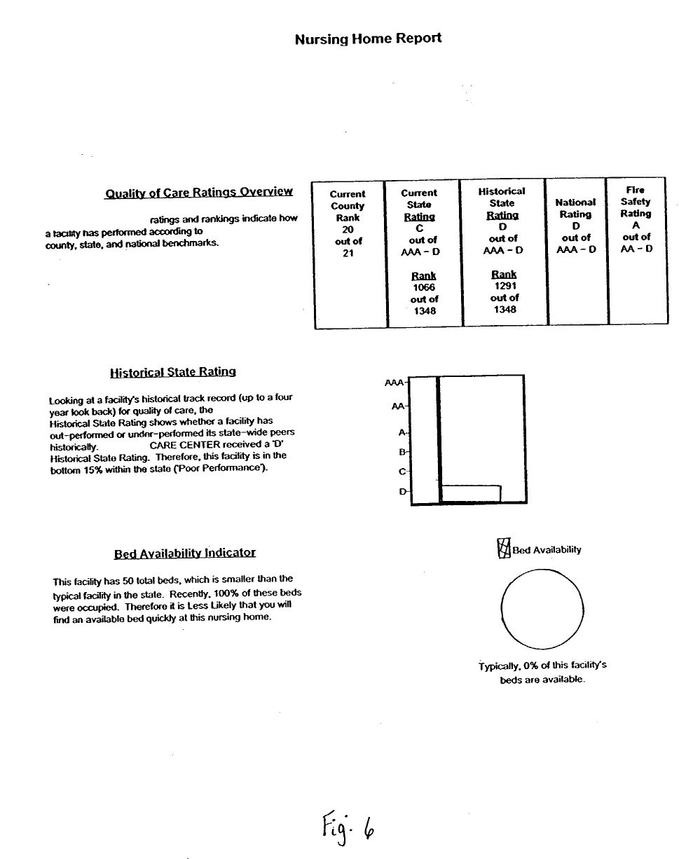

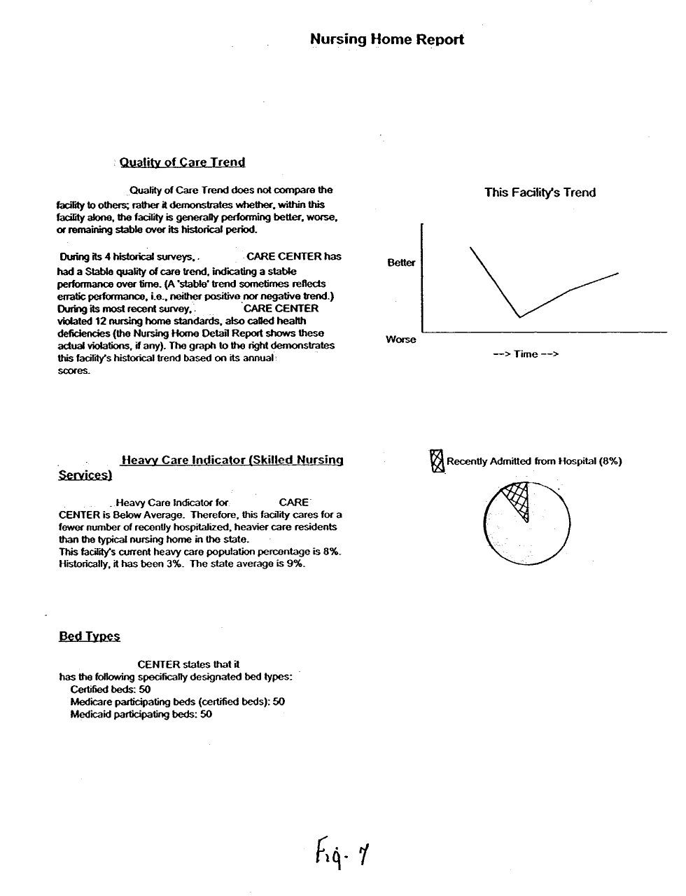

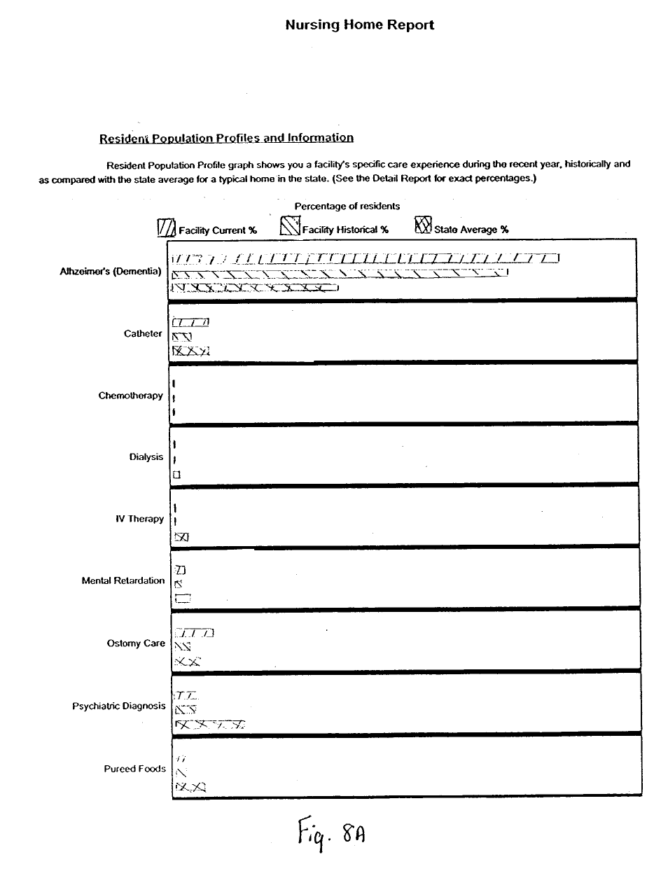

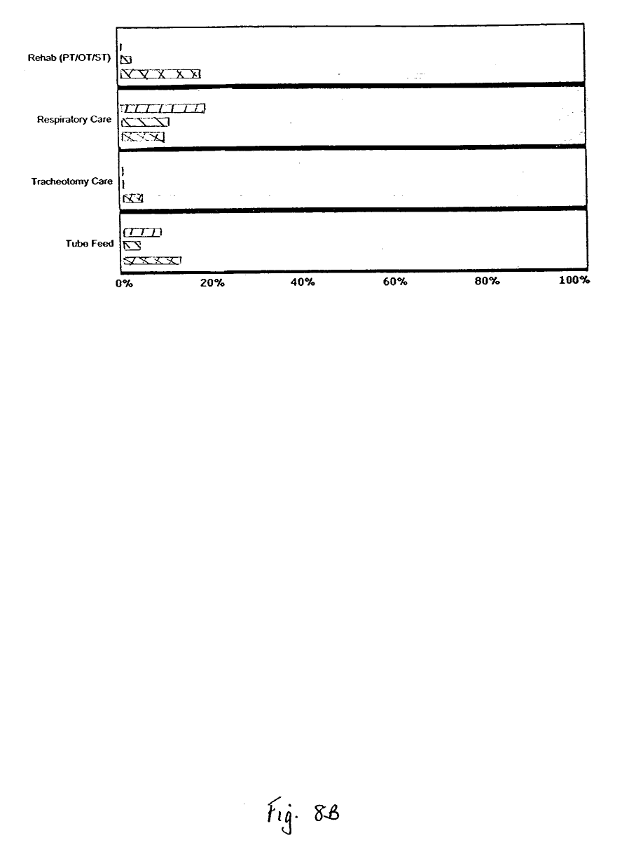

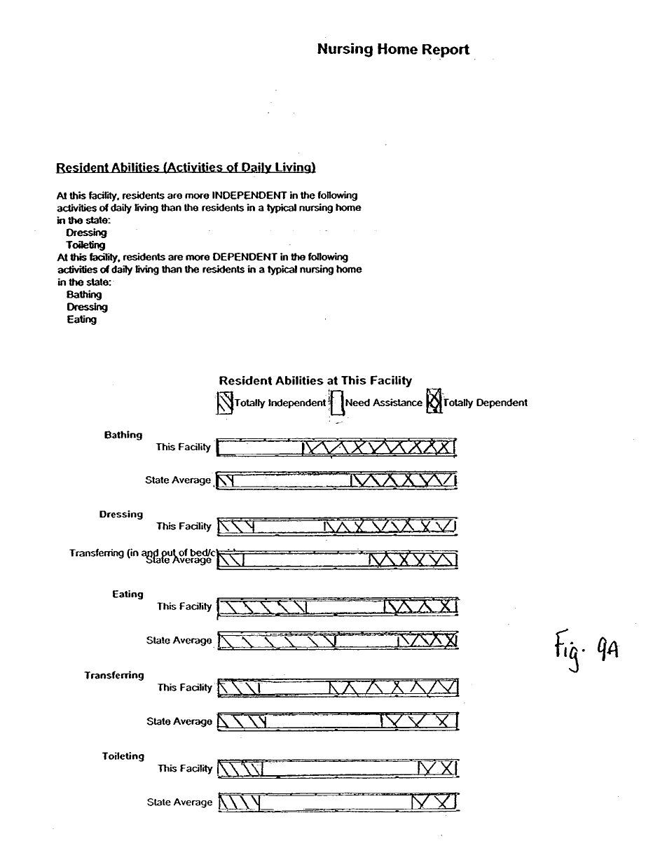

Referring to FIG. 3, and in further reference to FIG. 1 and FIGS. 4A-4C, in another aspect, the invention provides a computer implemented method 300 for providing services for user access to data and information related to care performance and performance ratings, rankings, reports and the like of one or more health care facilities. The method 300 further includes providing such performance data and information in a manner and a format that a user can access and use, e.g., to review performance of a number of health care facilities. In one embodiment, the method 300 is implemented via the general purpose computer system 10, as described above. Those skilled in the art will recognize that other types of automatic processing systems are suitable for implementing the method 300 according to the invention.

The system 10 is configured and arranged to provide services for user access to performance data and information compiled and created by computer software wherein at least a portion of the performance data and information the computer software creates includes performance ratings and rankings of health care facilities determined according to the method 100 of the invention described above with reference to FIG. 2. The system 10 can be further configured and arranged to provide services for user access to the computer software, the memory 13 and/or the one or more databases 15 associated with the system 10 that store such performance data and information.

In one embodiment, the method 300 employs the general purpose computer system 10 as part of a client-server system wherein the system 10 is configured and arranged as a server system that provides services to a client system, e.g., a user computer, such that the client system can access and search the computer software and/or the one or more databases 15 to retrieve performance ratings and rankings and other related performance data and information. In one embodiment, the method 300 includes operatively coupling the system 10 to the user computer, e.g., a personal or laptop computer, via a communications channel, for example, a network such as the Internet to provide user access to such performance data and information.

The method 300, as described below with reference to FIG. 3, and in further reference to FIG. 1 and FIGS. 4A-4C, is one example of providing services for user access to performance data and information related to health care facilities and is exemplary only and not limiting. The method 300 can be altered, e.g., by having stages added, removed or rearranged.

At stage 310, the system 10 receives a message a user sends from the user computer via a network, e.g., the Internet. In response to receipt of the message, the system 10 operatively connects to the user computer.

At stage 320, the system 10 receives one or more queries a user transmits to the system 10 via the user computer, e.g., using a web browser application running on the user computer. In one embodiment, the one or more queries can include search requests including one or more search parameters. The search parameters can include, for instance, requests for information related to one or more specific health care facilities, e.g., nursing homes or long term care facilities, designated by name in the search requests. The one or more search parameters can also relate to requests for information about health care facilities located in a specific geographical area or region, e.g., a city, county or state, designated, for instance, by a city name or a county name in the search requests.

In one embodiment, the system 10 can be further configured and arranged to operate a searching and matching function in accordance with instructions provided by the computer software whereby one or more queries received from the user are formatted as a selection of different search criteria. As shown in FIGS. 4A-4C, the system 10 can provide to the user computer, in response to the user's request, a search request module or online form, e.g., one or more HTML documents and/or WWW documents including, but not limited to, web pages written in HTML. The search request module or form can provide different search criteria that the user selects to format a search request for performance data and information. In one embodiment, the user selects in the request form one or more criteria to format a search request and to define the performance data and information desired, which the system 10 receives from the user computer as a formatted search request. The search criteria can relate to different characteristics and types of parameters related to nursing homes or long term care facilities. As shown in FIGS. 4A-4C, search criteria can include, but are not limited to, the geographical location of a facility, e.g., selected in the search form as a city, county or state, the size of a facility, e.g., selected as number of beds per facility, the types of rehabilitation provided by a facility, e.g., selected as a number of facility residents receiving rehabilitation services, the extent of psychiatric diagnoses, e.g., selected as a number of facility residents having a psychiatric diagnosis, the special types of care with which a facility has experience, e.g., selected as one or more characteristics of care such as chemotherapy, and other criteria related to, for instance, a facility's physical characteristics and a facility's funding and financial assistance. The method 300 of the invention, however, is not limited with respect to the number and type of criteria by which the system 10 can operate the searching and matching function to provide a user access to performance ratings and ranks and other related performance data and information.

At stage 330, in response to the system 10 receiving the one or more user queries, the system 10 operatively connects the user computer to the system 10 such that the user computer can access performance data and information. In one embodiment, the system 10 can operatively connect to the user computer and can provide the user computer with access to at least one of the one or more databases 15 associated with the system 10 in which ratings and rankings and other performance related data and information is managed and stored. In another embodiment, the system 10 can receive the one or more user queries as a formatted search request as described above. In accordance with the computer software, the system 10 searches, e.g., one or more of the databases 15 associated with the system 10, to retrieve, e.g., from at least one of the databases 15, performance data and information including ratings and rankings related to one or more facilities that comply with or “match” the search criteria identified in the formatted search request. In one embodiment, the performance ratings and rankings are determined according to the method 100 of FIG. 2 wherein customized scores and customized weighting factors are used to calculate the ratings and rankings.

At stage 340, the system 10 is further configured and arranged to provide the retrieved performance ratings and rankings and other related performance data and information to the user computer in a manner and a format such that the user computer displays such performance data and information in a presentation that is accessible and easily understandable by the user.

Referring to FIG. 5, in one embodiment, the system 10 is configured and arranged to provide final facility scores or performance ratings and rankings and other performance related data and information for one or more facilities that the system 10 “matches” to the criteria identified in one or more user queries or formatted search requests. FIG. 5 shows a representative example of a screen shot of an HTML document or a WWW document, e.g., a web page written in HTML, the system 10 provides to the user computer according to the method 300 of the invention. The screen shot displays the final facility scores or performance ratings and rankings of a set of six nursing homes the system 10 retrieved in response to a request for information related to nursing homes within a certain state, e.g., Massachusetts, and a certain county, e.g., Norfolk, as indicated in the search request shown in FIG. 4A.

The performance ratings and rankings displayed in FIG. 5 are represented by “Historical” and “Current” ratings and rankings. The third column of the screen shot displays the “Historical” performance ratings and comparative “Historical” rankings of the six nursing homes. The “Historical” rating of each facility, as created according to stages 250 and 260 of the method 100 described above, is expressed by an alphabetical rating system, e.g., AAA, AA, A, B, C, D, wherein AAA represents a highest rating. The comparative “Historical” ranking of each facility, as determined according to stage 270 of the method 100, is represented by a numerical rank or position of the facility within the total population of facilities in a given area, e.g., Norfolk County, Massachusetts, wherein the higher the rank, the better the performance of a facility in comparison to all facilities in the given area. The fourth column shown in FIG. 5 displays the “Current” performance ratings and rankings of the six facilities wherein the “Current” rating and ranking reflects the most recent performance data and rating and rank as determined by the method 100 of the invention. For example, the screen shot indicates that the nursing home named “Clark House” has a “Historical” rating of “A” and a “Current” rating of “AAA”, a “Historical” rank of “192 out of 510 providers” and a “Current” rank of “Best out of 510 providers”, suggesting that this facility's performance in providing nursing care received a relatively high rating and ranking in comparison to other similar facilities located in Norfolk County, Massachusetts.

Other information about a facility can be displayed by the screen shot of FIG. 5 including, but not limited to, the likelihood of an available bed at the facility, displayed, for example, as the “Bed Availability Indicator”, the “Total Number of Beds” at the facility, the number of miles the facility is located from a given zip code, displayed as “Miles from Zip Code”, and an icon or link designated “Community Reviews” to connect to other HTML documents and/or web pages or web sites that provide community reviews of the associated facility.

The screen shot can further include an icon or link designated “Order Report”, as displayed in the second column of FIG. 5, or an order area in the screen shot (not shown), to allow a user to order electronically a copy of a “Report” about a facility.

In one embodiment, the system 10 is configured and arranged to provide the “Report” to the user computer and can include one or more reports and/or summaries including a facility's performance ratings and rankings as created by the method 100 of the invention. The “Report” can provide other performance related data and information the system 10 and the computer software at least compiles and stores in connection with the facility, including, but not limited to, the inspections performed at the facility, the ranking information used to determine the facility's rank, data on patients residing at the facility and the like, to provide further information about the care performance of the facility. The “Report” can provide summaries and reports including the same or similar information as the raw data and information received at stage 105 of the method 100 of FIG. 2; however, the system 10 is configured and arranged to provide summaries and reports that present such raw data and information in a manner and a format that is understandable to a user. The “Report” can provide summaries and reports including other raw data and information that is not received at stage 105 of the method 100, and can include other data or information.

Referring to FIGS. 6-14, a representative example of a “Report” about a specific nursing home that the system 10 provides to the user computer for access and display is shown. In one embodiment, the “Report” can include a multi-page HMTL document and can be entitled “Nursing Home Report”, as shown. In response to receipt of an electronic request for a “Report”, e.g., sent via the “Report” icon associated with a specific nursing home as shown in FIG. 5, the system 10 retrieves the appropriate “Report” corresponding to the designated nursing home and downloads the “Report” to the user computer for display and user access.

FIG. 6 illustrates one page of the “Report” that can include a “Current County Rank” that represents a rank of the designated nursing home with respect to other similar facilities in a given county based on each facility's most recent final facility score or performance rating, as determined by the method 100 of the invention of FIG. 2. Each facility's score or rating takes into account the importance and the scope and severity of the facilities' performance violations and/or deficiencies as discuss above, as well as other performance measures that can be taken into account. In at least one embodiment, methodology to determine the “Current County Rank” includes grouping and comparing final facility scores or performance ratings of a number of facilities in a given county, as described above in stage 280 of the method 100 of the invention; however, determining the “Current County Rank” is not limited to such methodology and can be determined by other methods.

The “Current County Rank” reflects the designated nursing home's short-term quality of care performance countywide. The closer a nursing home's rank is to the top of a range of ranks, e.g., 1 out of 10, the more likely the facility has few violations that are deemed important and/or prevalent. For example, the “Current County Rank” shown in FIG. 4, e.g., “20 out of 21”, indicates that the nursing home in question is ranked one of the worst in the county in which it is located.

In addition, the “Report” can include a “Current State Rank” that ranks facilities within a given state in which they are located based on each facility's single most recent survey performance rating or final facility score as determined by the method 100 of FIG. 2. The “Current State Rank” reflects the designated nursing home's short-term quality of care performance statewide. In at least one embodiment, the “Current State Rank” methodology parallels methodology used to determine the “Current County Rank”; however, rather than grouping and comparing final facility scores or performance ratings by county, the “Current State Rank” methodology groups and compares the ratings or scores of facilities by state. In one embodiment, the “Current County Rank” and the “Current State Rank” are each a numerical value or number that represents a rank of the designated nursing home among those nursing homes within the state or county whose performance is assessed, rated and ranked according to the method 100 of the invention of FIG. 2.

As shown in FIG. 6, the “Report” can include an “Historical State Rating” of the designated nursing home represented by an alphabetical code, e.g., AAA, AA, A, B, C, D etc., or other rating system. The “Historical State Rating” can be considered as one of the most accurate indicators of a nursing home's quality of care and indicates whether the nursing home has out-performed or under-performed its peers on quality of care survey inspections and assessments, as well as other reviews, over a historical period. As shown, the “Historical State Rating” reflects the designated nursing home's long-term quality of care performance statewide. In at least one embodiment, the “Historical State Rating” rates similar facilities by comparing the facilities' care performance by methodology paralleling methodology used to determine the “Current County Rankings”, but employs a specific number, e.g., 4, of each facility's most recent final facility scores or performance ratings rather than a single or the most current score or performance rating. The scores or performance ratings used to determine the “Historical State Rating” is not limited, and the method 100 of the invention anticipates using any number of the most recent final facility scores or performance ratings determined for the designated nursing home.

Table II lists Historical Nursing Home Performances and corresponding Historical State Performance Ratings employed in the “Report” according to this embodiment of the invention. As noted above, the “Historical State Rating” is represented as a letter code, although those skilled in the art will recognize that other indicators can represent the breakdown of nursing home performance.

TABLE II

| Historical | Historical |
|---|---|
| Nursing Home | State Performance |
| Performance | Rating |
| No Health | AAA |
| Deficiencies | |
| Top 15%* | AA |
| in the state | |
| Next best 20%* | A |
| Next best 30%* | B |
| Next best 20%* | C |
| Worst 15%* | D |
| in the state | |

*Excluding *AAA* rated facilities

The “Report” can also include a “Historical State Rank”. The “Historical State Rank” indicates the designated nursing home's performance over a historical period and in comparison to its peers. The “Historical State Rank” is determined by methodology that parallels methodology used to determine the “Current State Rank” wherein the most recent, e.g., last 4 years, final facility scores or performance ratings are used to determine the comparative rank of the nursing home statewide over a certain period of time.

As shown in FIG. 6, the “Report” can include a “National Rating” that represents a comparison of the designated nursing home's historical final facility scores or performance ratings with other similar facilities, e.g., certified nursing homes, in the United States. Employing the most recent, e.g., last 4 years, performance ratings or final facility scores of each of the facilities within the United States whose performance is determined by the method 100 of the invention determine the “National Rating”. The historical performance ratings of the designated nursing home are grouped and compared with other similar facilities' historical performance ratings located across the U.S to produce the “National Rating”.

The “Report” can further include the “Fire Safety Rating” of the designated nursing home. The “Fire Safety Rating” reflects a fire and life safety status of a facility's physical plant. The “Fire Safety Rating” is based on a recent amount of fire and life safety code violations and/or deficiencies existing in a facility's physical plant that takes into account the facility's size. In one embodiment, fire and life safety code violations and deficiencies are assessed by the Life Safety Code (LSC) Survey conducted during an annual inspection survey to assess a facility's compliance with the National Fire Protection Association's Life Safety Code. The Life Safety Code provisions are enforced by the onsite surveyors during the annual survey inspection of certified nursing facilities. The results are reported within the federal OSCAR database reporting system for certified nursing facilities. Facilities are rated by assigning a “Fire Safety Rating” to reflect their respective fire and life safety status. Table III lists Life Safety Code Performances and corresponding “Fire Safety Ratings” employed in the “Report” according to this embodiment of the invention.

TABLE III

| Life Safety Code (LSC) | |
|---|---|
| Performances | Fire Safety Rating |
| Zero LSC Deficiencies | AA |
| Top 25% | A |
| Next best 25% | B |
| Next best 25% | C |
| Worst 25% | D |

A “Bed Availability Indicator” can also be included in the “Report”, as shown in FIG. 6.

The “Bed Availability Indicator” represents likelihood, e.g., greater or lesser probability, a patient or resident can be admitted or accepted into a facility. The “Bed Availability Indicator”, as shown, indicates, e.g., by a representative percentage, the likelihood of an available bed at the designated nursing home. The “Bed Availability Indicator” can be represented by a graphic, e.g., a shaded portion of a pie, and/or as a percentage. The percentages can correspond to one or more indicators of availability such as, but not limited to, “Very Likely” and “Somewhat Likely”, to indicate a relatively high likelihood of an available bed, and “Less Likely”, to indicate a relatively low likelihood of an available bed. The indicators can be included in the “Report”, as shown in FIG. 4, as text that accompanies the graphic and the percentage indicators.

Another page of the “Report” is shown in FIG. 7 that can include a “Quality of Care Trend”. The “Quality of Care Trend” tracks a facility's historical performance to determine whether the facility is improving, remaining stable, or doing worse over a period of time. The “Quality of Care Trend” of the designated nursing home indicates a trend of improving or worsening performance over time, e.g., as illustrated by an X, Y graph. One or more indicators can be used to report a trend over time, as well, including, but not limited to, such indicators as “positive”, “stable”, and “negative”, and can be included, for instance, in text of the “Report”.

A “Heavy Care Indicator”, which represents a number of residents at a facility that require relatively heavier levels of care, e.g., more recently hospitalized patients, can be included in the “Report” to provide an indication of the number of heavy-care residents at the designated nursing home. In addition, a “Bed Types Indicator” can be included that represents a breakdown of different bed types by type of care given at a facility, including specially designated care beds and certified beds, and/or a breakdown of bed types by health care insurance coverage applied, e.g., Medicare and Medicaid. The number of beds that fit each designated bed type can be provided. Although the “Bed Types Indicator” may not designate a number of specially designated care beds, e.g., a number of beds for Alzheimer's disease patients, the lack of such an indicator does not necessarily mean that a facility does not care for residents with Alzheimer's disease.

The “Report” can further include, as shown in FIGS. 8A-8B, a “Resident Population Profiles & Information” chart that provides, for example, the percentage of a facility's population with, for instance, dementia, including Alzheimer's Disease, or the percentage of patients receiving rehabilitation. The “Resident Population Profiles & Information' provides current, historical and state percentages of residents at a facility with a particular diagnosis or receiving certain care or services are listed under “Resident Information”.

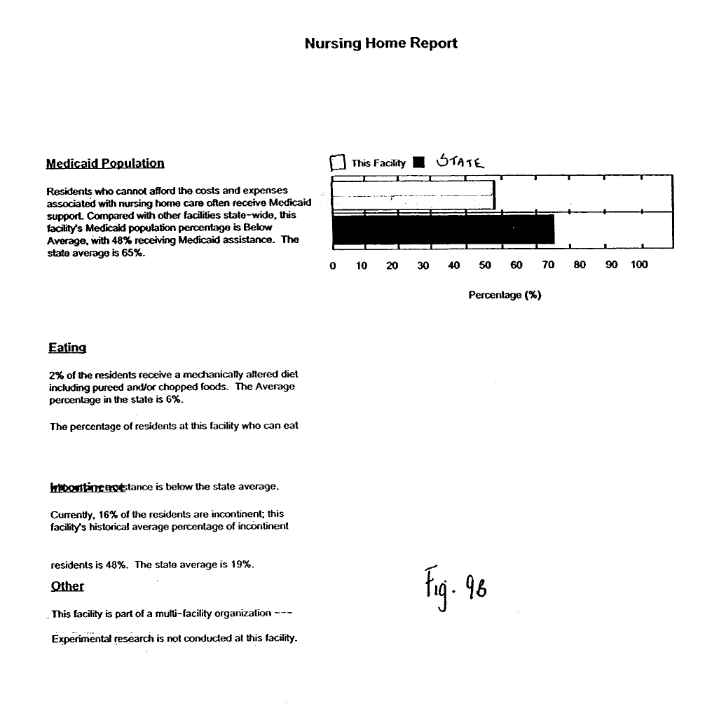

Referring to FIGS. 9A-9B, percentages of “Resident Abilities” can be provided in the “Report” to indicate percentages of residents in a facility who are totally independent and who are totally dependent in their abilities to bathe, dress, eat, transfer, e.g., move from bed to chair, and use the toilet. These percentages can be provided in the “Report” as current, historical average, and state percentages for each characteristic or ability. As shown, the designated nursing home of the “Report” indicates that large percentage, e.g., 50% or more, of the residents are totally dependent with respect to bathing and dressing.

A “Medicaid Population Indicator” is shown in FIG. 9B that indicates a percentage of residents within a facility who rely upon Medicaid to pay for all or part of their nursing home costs and expenses as of the date of the facility's most recent inspection. Medicaid, a shared state and federal program, may pay all or part of a person's nursing home costs for people who cannot afford to pay and who qualify for state Medicaid benefits. A facility with a low “Medicaid Population Indicator” or percentage may reflect a population whose nursing home costs are primarily paid for with private funds or alternative resources. Conversely, a facility with a high “Medicaid Population Indicator” or percentage may reflects a population whose nursing home costs are primarily paid for with Medicaid resources. Medicaid population does not necessarily reflect a facility's quality of care. As shown in FIG. 7B, about 48% of the resident population of the designated nursing home receives Medicaid assistance to pay for all or part of nursing costs and expenses.

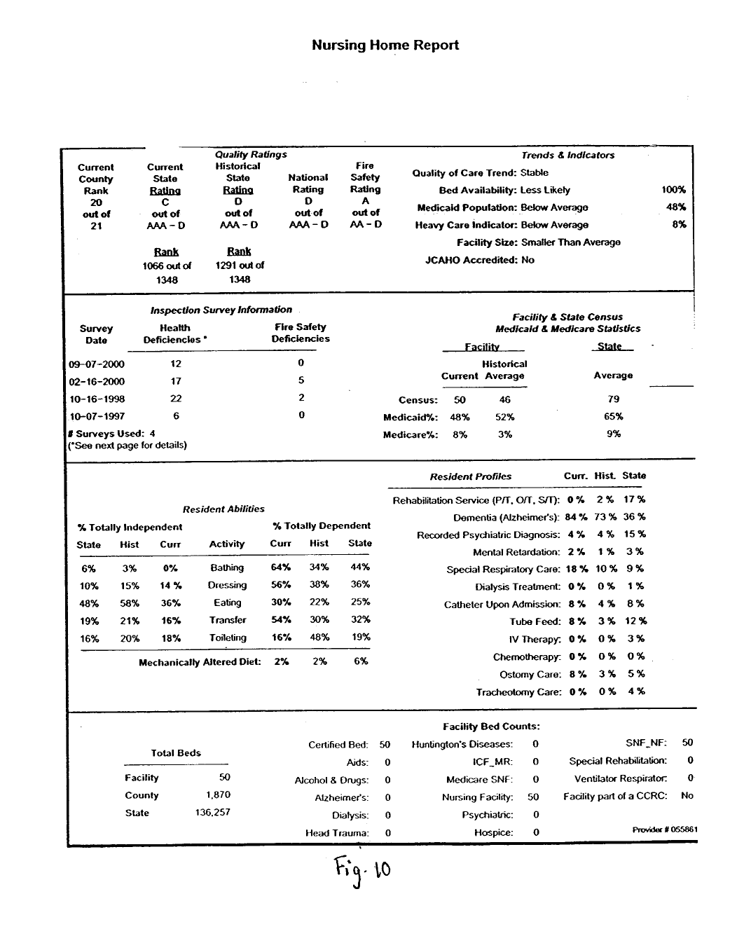

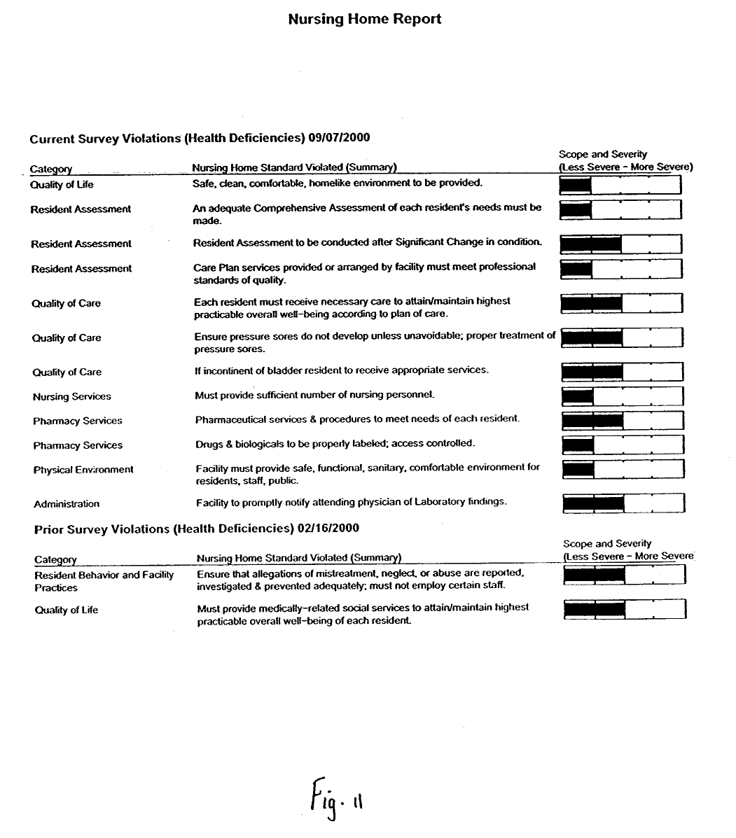

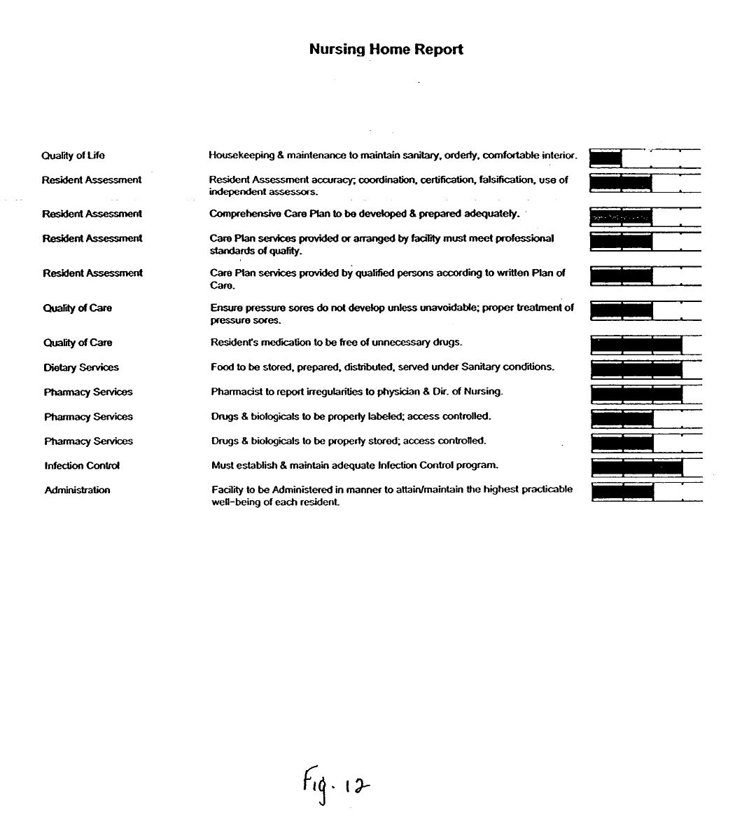

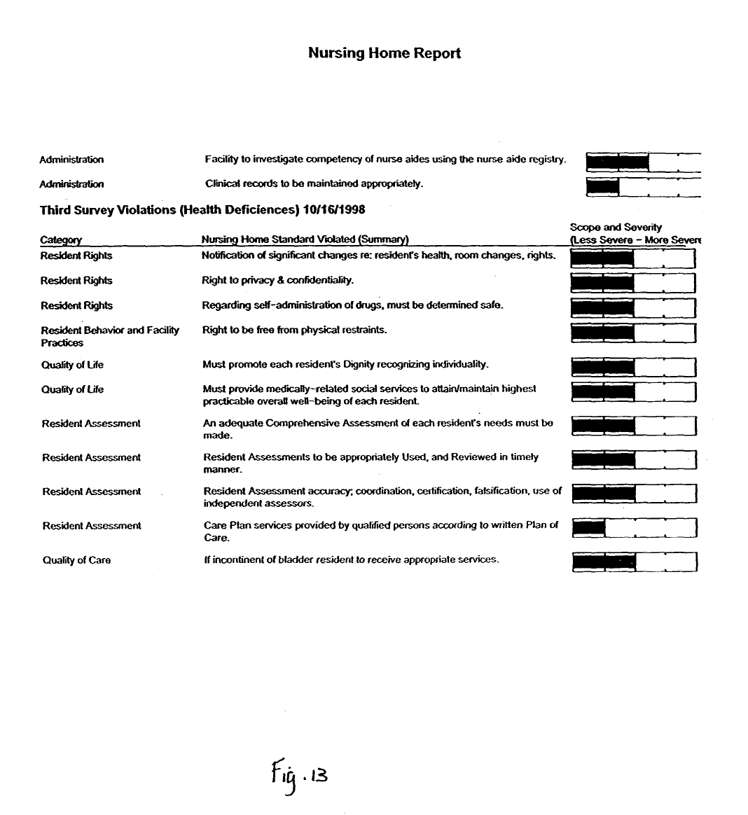

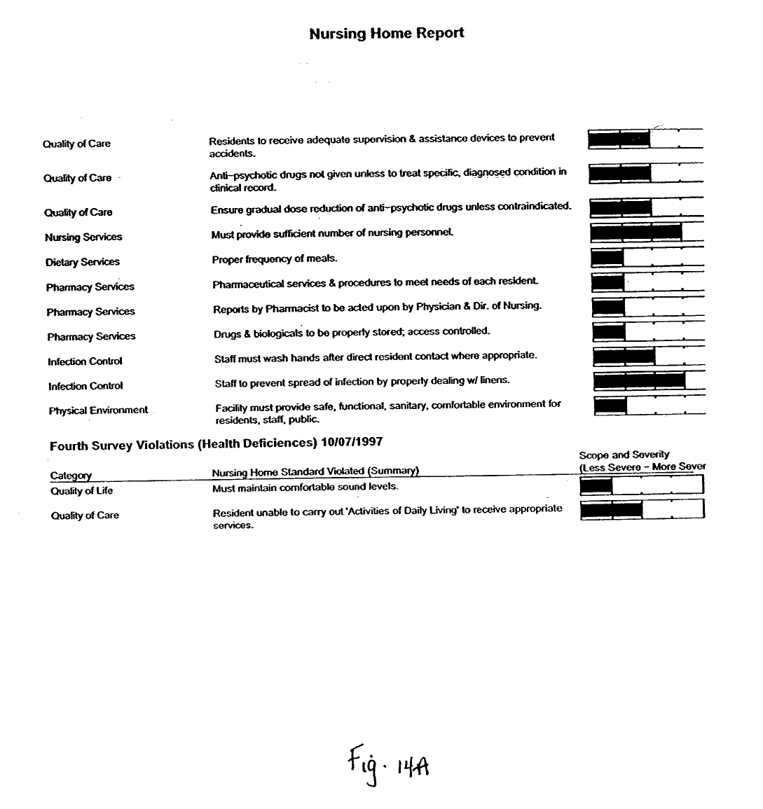

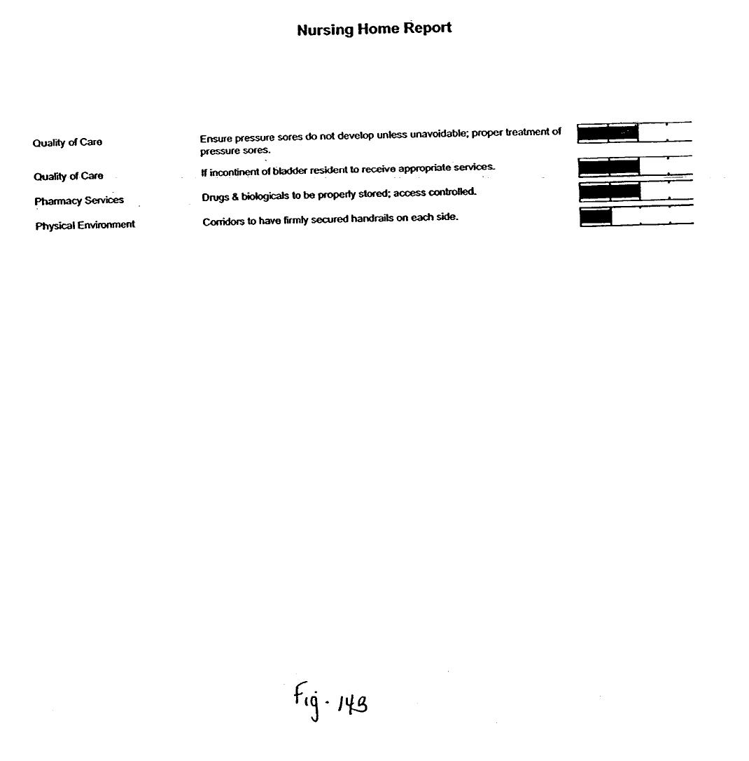

FIGS. 10-14B provide other representative pages of the “Report” that can be included and which summarize additional information about the designated nursing home in accordance with this embodiment. For example, the portions of the “Report” shown in FIGS. 11-12 report information related to the scope and severity of violations and deficiencies assessed at a facility. The scope and severity of the violations and deficiencies are represented by a graph that illustrates a scope and severity of each violation or deficiency in a range from Less Severe to More Severe as assessed from a current performance survey and a prior survey. The graph provides users with a visual representation of the actual violations and deficiencies of a facility. In addition, FIGS. 13-14B provide the scope and severity of the violations and deficiencies assessed from surveys of the facility that were conducted one or more years before the current and prior surveys to provide a historical picture of the scope and severity of violations and deficiencies.

In accordance with the descriptions of the invention provided herein, it should be understood that although the systems and methods of the present invention have been heretofore described in relation to comparison of health care facilities, the invention is not limited to that application. Those skilled in the art will appreciate that the invention has applicability to virtually any type of comparison or analysis, especially where a considerable amount of data, both subjective and objective, are involved in making a meaningful comparison. For example, the invention could be used to create a rating and ranking system for colleges, universities, or graduate schools. The invention also could be used to rate and rank different areas of the United States for lifestyle characteristics, e.g., cost of living, crime rate, population density, etc. Another application for the invention is for rating and ranking financial products, such as mutual funds and stocks.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting.

What is claimed is:

1. A method of determining a performance rating of a health care facility, the method comprising:
obtaining information related to performance of the health care facility;
identifying at least a first performance identifier from the information, the first performance identifier being indicative of a first violation of one or more standards of care;
determining a first score corresponding to the first performance identifier, the first score being indicative of an importance of the first violation to the performance rating of the health care facility;
assigning a first weighting factor to the first performance identifier, the first weighting factor being indicative of an importance of the first violation to the performance rating relative to other violations of standards of care; and
weighting the first score by the first weighting factor to produce a second score, the second score being indicative of the performance rating of the health care facility with respect to the first violation.

2. The method of claim 1 further comprising:
assigning a second weighting factor to the first performance identifier, the second weighting factor being indicative of a scope of the first violation at the health care facility and a severity of the first violation with respect to potential and actual harm to patients at the health care facility; and
weighting the second score by the second weighting factor to produce a first preliminary score, the first preliminary score being indicative of the performance rating of the health care facility with respect to the first violation and its scope and severity at the health care facility.

3. The method of claim 1 further comprising:
identifying a second performance identifier from the information, the second performance identifier being indicative of a second violation of one or more standards of care; and
producing a second score with respect to the second violation according to the method of claim 1.

4. The method of claim 3 further comprising:
assigning a second weighting factor to the second performance identifier, the second weighting factor being indicative of a scope of the second violation at the health care facility and a severity of the second violation with respect to potential and actual harm to patients at the health care facility; and
weighting the second score by the second weighting factor to produce a second preliminary facility score, the second preliminary score being indicative of the performance rating of the health care facility with respect to the second violation and its scope and severity at the health care facility.

5. The method of claim 5 further comprising summing the first preliminary score and the second preliminary score to produce a preliminary facility score.

6. The method of claim 5 further comprising:
assigning a census factor to the preliminary facility score, the census factor being indicative of a standard population size of a health care facility; and
weighting the preliminary facility score by the census factor to produce a final facility score, the final facility score being indicative of the performance rating of the health care facility with respect to the first and the second violations, the scope and severity of the first and the second violations and a size of the health care facility's population.

7. The method of claim 1 wherein the information includes at least one of performance data, federal inspection data, state inspection data, and compliance data.

8. The method of claim 1 wherein the one or more standards of care include one or more regulations related to health care associated with the United States Department of Health and Human Services.

9. The method of claim 8 wherein the one or more regulations included one or more long term care regulations issued by the United States Department of Health and Human Services.

10. The method of claim 9 wherein the first performance identifier includes one of a violation within one or more long term care regulations and a deficiency within one or more long term care regulations.

11. The method of claim 10 wherein the first performance identifier includes an F-tag.

12. The method of claim 1 wherein the information includes information provided by at least one of the Center for Medicare and Medicaid Services (CMS), the Joint Commission on Accreditation of Healthcare Organizations (JCAHO), and the Online Survey Certification and Reporting (OSCAR) database.

13. The method of claim 1 wherein the information includes information related to fire safety violations.

14. A computer implemented method for providing services to access a performance ratings database, the method comprising:
connecting a first computer operatively to a user computer via a network;
receiving with the first computer one or more queries sent from the user computer, the one or more queries being related to requests for information about at least one health care facility;
connecting the user computer to the performance ratings database using the first computer,
searching the performance ratings database using the user computer; and
retrieving data from the performance ratings database using the user computer, wherein data includes at least one performance rating of the health care facility created by:
(i) identifying at least one performance identifier from raw data and information about the health care facility, the performance identifier being indicative of a violation of one or more standards of care;
(ii) determining a first score corresponding to the performance identifier, the first score being indicative of an importance of the violation to the performance rating;
(iii) assigning a first weighting factor to the first score, the first weighting factor being indicative of an importance of the violation to the performance rating relative to other violations;
(iv) weighting the first score by the first weighting factor to generate a second score;
(v) assigning a second weighting factor to the second score, the second weighting factor being indicative of a scope of the violation at the health care facility and a severity of the violation with respect to potential and actual harm to patients at the facility; and
(vi) weighting the second score by the second weighting factor to generate a performance rating of the health care facility with respect to the violation.

15. A computer implemented method of determining a performance rating of a health care facility, the method comprising:
obtaining information related to performance of the health care facility and entering such information into a computer via an input device;
entering instructions into the computer to identify at least one performance identifier from the information, the performance identifier being indicative of at least one violation of one or more standards of care stored in the computer;
entering instructions into the computer to compare the performance identifier to one or more scores stored in the computer, the scores being indicative of an importance of violations to the performance rating of the health care facility;
entering instructions into the computer to identify a first score associated with the performance identifier from scores stored in the computer, the first score being indicative of an importance of the at least one violation to the performance rating;
entering instructions into the computer to assign a first weighting factor to the first score from a set of stored first weighting factors, the first weighting factor being indicative of an importance of the at least one violation to the performance rating relative to an importance of other violations to the performance rating; and
entering instructions into the computer to weight the first score by the first weighting factor to generate a second score, the second score being indicative of the performance rating of the health care facility with respect to the at least one violation.

16. The method of claim 15 further comprising
entering instructions into the computer to assign a second weighting factor to the second score from a set of second weighting factors stored in the computer, the second weighting factor associated with the second score being indicative of a scope and a severity of the at least one violation at the health care facility with respect to potential and actual harm to patients; and
entering instructions into the computer to weight the second score by the second weighting factor to generate a preliminary facility score, the preliminary facility score being indicative of the performance rating of the health care facility with respect to the at least one violation and its scope and severity at the health care facility.

17. The method of claim 16 further comprising:
entering instructions into the computer to assign a census factor to the preliminary facility score from a set of census factors stored in the computer, the census factor being indicative of a size of a standard patient population; and
entering instructions into the computer to weight the preliminary facility score by the census factor to generate a final facility score, the final facility score being indicative of the performance rating of the health care facility with respect to the at least one violation and its scope and severity at the health care facility, and a population size of the health care facility.

18. A computer system arranged to generate a performance rating for at least one health care facility, the system comprising:
(i) an input device configured for inputting health care performance data;
(ii) a database configured for storing the data inputted by the input device, one or more standards of care, and one or more weighting factors;
(iii) a processor configured for processing the data; and
(iv) a device for outputting the performance rating
wherein at least a portion of the data stored in the database relates to violations of one or more of the standards of care stored in the database and the processor is arranged to compare the data to the standards of care and to identify from the data at least a first violation of one or more of the standards of care; the processor being arranged to assign to the first violation a first score from a set of scores stored in the database, the first score being indicative of an importance of the first violation to the performance rating; and the processor being further arranged to assign to the first violation a first weighting factor from the weighting factors stored in the database, the first weighting factor being indicative of an importance of the first violation to the performance rating relative to other violations, and to weight the first score by the first weighting factor to produce a second score, the second score being indicative of the performance rating of the health care facility with respect to the first violation.

19. The system of claim 18 wherein the processor is arranged to assign to the second score a second weighting factor from the weighting factors stored in the database, the second weighting factor being indicative of a scope of the first violation at the health care facility and a severity of the violation at the health care facility with respect to actual or potential harm to patients of the health care facility, and to weight the second score by the second weighting factor to generate a first preliminary score, the preliminary score being representative of the performance rating of the health care facility with respect to the first violation and its scope and severity at the health care facility.

20. A computer readable medium containing at least a program of instructions that when run on a computer system causes the system to act as a computer system of claim 18.

21. A computer readable medium containing at least a program of instructions that when run on a computer system causes the system to act as a computer system of claim 19.
